(19) United States
(12) Patent Application Publication
(10) Pub. No.: US 2019/0364844 A1
(43) Pub. Date: Dec. 5, 2019

(54) ANIMAL PROTECTION AND CARE SYSTEM AND METHOD OF USE

(71) Applicant: Darren Mark Teren, San Diego, CA (US)

(72) Inventor: Darren Mark Teren, San Diego, CA (US)

(21) Appl. No.: 16/428,974

(22) Filed: Jun. 1, 2019

Related U.S. Application Data
(60) Provisional application No. 62/679,295, filed on Jun. 1, 2018.

(51) Int. Cl. A01K 1/06; A01K 1/02

(52) U.S. Cl. CPC A01K 1/0613; A01K 1/0281; A01K 1/0254

(57) ABSTRACT

An animal protection apparatus includes a body with a collar to secure around an animal's body and neck; a padded base attached to the body; and a net positioned under the padded base; the net and padded base can fold around the animal's body and can be used to lift and carry the animal.

### BACKGROUND

### 1. Field of the Invention

The present invention relates generally to animal securing systems, and more specifically, to an animal protection and care system that provides for easy transportation and care for an animal, particularly when/if an animal is injured.

### 2. Description of Related Art

Animal securing systems are well known in the art and are effective means to guide and control an animal. For example, FIG. 1 depicts a conventional collar 101 having a band 103 with a loop 105 for attaching a leash (not shown) and one or more buckles 107 for securing the collar around the neck of the animal. During use, the collar is secured to the animal, and the animal is guided by the user as needed and desired.

One of the problems commonly associated with system 101 is limited transportation. For example, should an animal become injured, the owner may have to physical lift the animal and carry them to safety, this can be difficult for the owner, and may even result in more damage or danger to the pet.

Accordingly, although great strides have been made in the area of animal securing systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is an isometric view of a conventional collar;

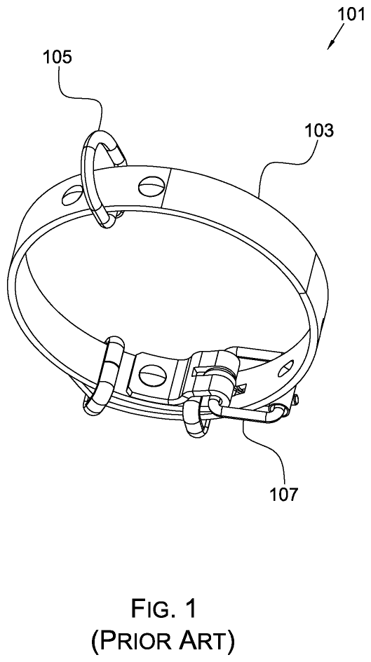

FIG. 2 is a side view of an animal protection system in accordance with a preferred embodiment of the present application;

FIG. 3 is an isometric view of the system of FIG. 2;

FIG. 4 is a cross sectional view of the system of FIG. 2;

FIG. 5 is an isometric view of a net of the system of FIG. 2;

FIG. 6 is an isometric view of a body portion of the system of FIG. 2;

FIG. 7 is a top view of an animal protection system in accordance with an alternative embodiment of the present application;

FIG. 8 is a back view of the protection system of FIG. 7; and

FIG. 9 is a flowchart of the method of use of the systems of the present invention.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional animal securing systems. Specifically, the system of the present invention provides for a safe and secure way to secure and transport an animal as needed. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

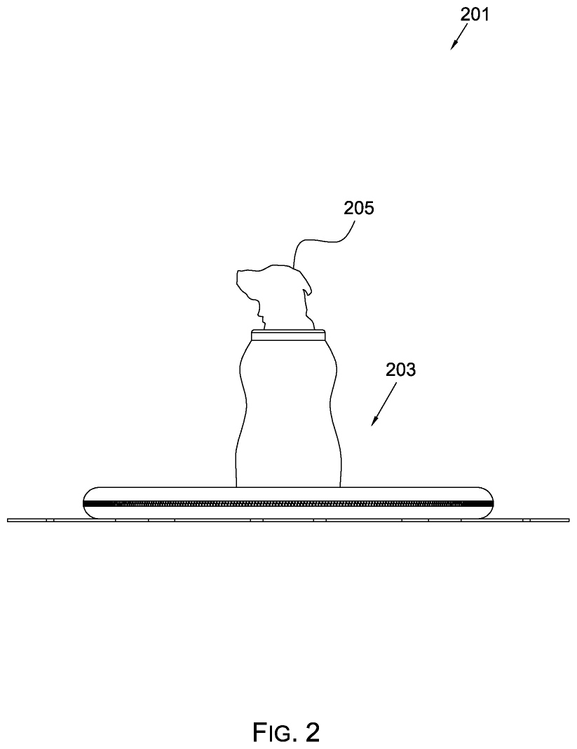

Referring now to the drawings wherein like reference characters identify corresponding or similar elements throughout the several views, FIG. 2 depicts a side view of an animal protection system 201 in accordance with a preferred embodiment of the present application. It will be appreciated that system 201 overcomes one or more of the above-listed problems commonly associated with conventional animal securing systems.

In the contemplated embodiment, system 201 includes a protection apparatus 203 configured to secure to an animal 205 and provide a means to safely support and transfer the animal. It should be appreciated that the system is not limited to dogs, but could be used for cats, livestock, or any other animal.

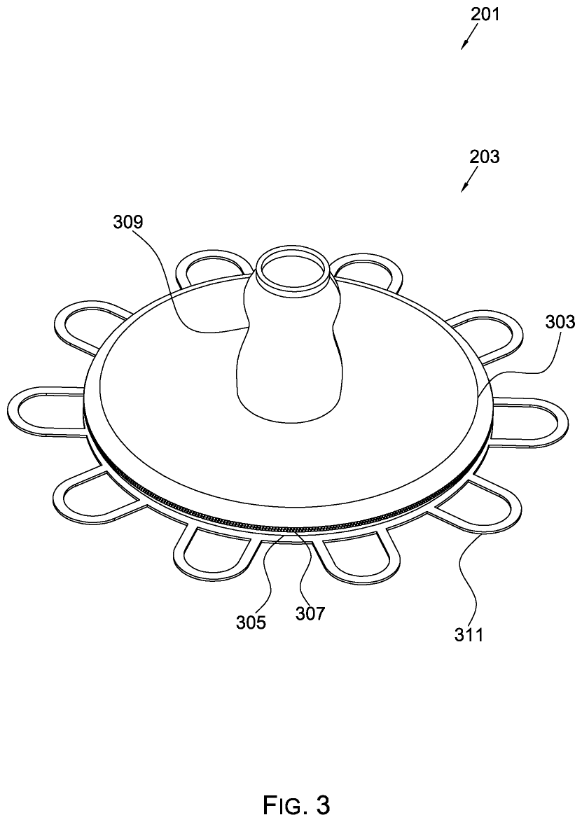

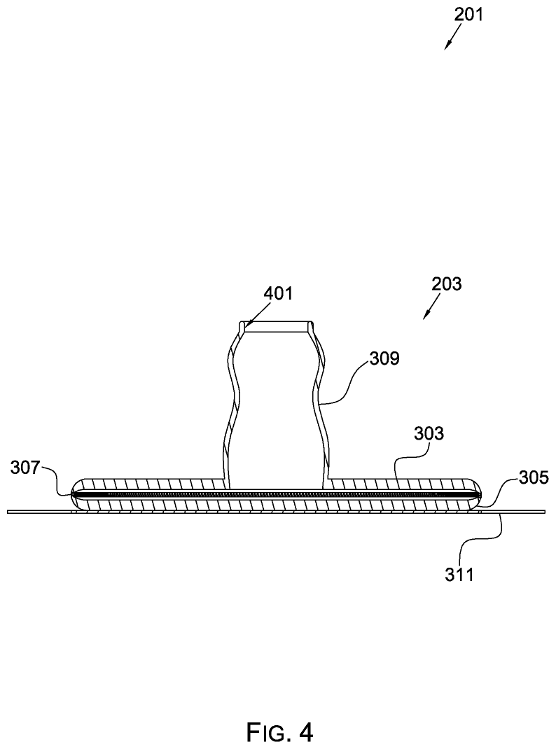

As shown in FIGS. 3 and 4, the protection apparatus 203 includes a body 309 with a collar portion 401 configured to secure around a neck of the animal and provide protection to the body of the animal. The collar portion 401 can be adjustable and secures such that the animal's body is securely positioned within the rest of the body. The body 309 can be composed of materials, including flexible fabrics, and the like, and can include paddings or the like. The body 309 is attached to a base 303 which is preferably padded, thereby providing for additional comfort and support for the animal. The base 303 can include a bottom 305 attached via a zipper 307 thereby providing for an interior area that can be filled for comfort. The apparatus 203 further includes a net 311 which is positioned under the base, and can either be attached to the base 303 or separate. The net 311 provides for a means to fold the apparatus up and around the animal, and provides for locations to be gripped by one or more people to lift and carry the animal within the apparatus.

It should be appreciated that one of the unique features believed characteristic of the present application is the configuration of features, namely the body, base, and net, that allows for the user to secure the apparatus to the animal, and have a better means to lift and transport the animal.

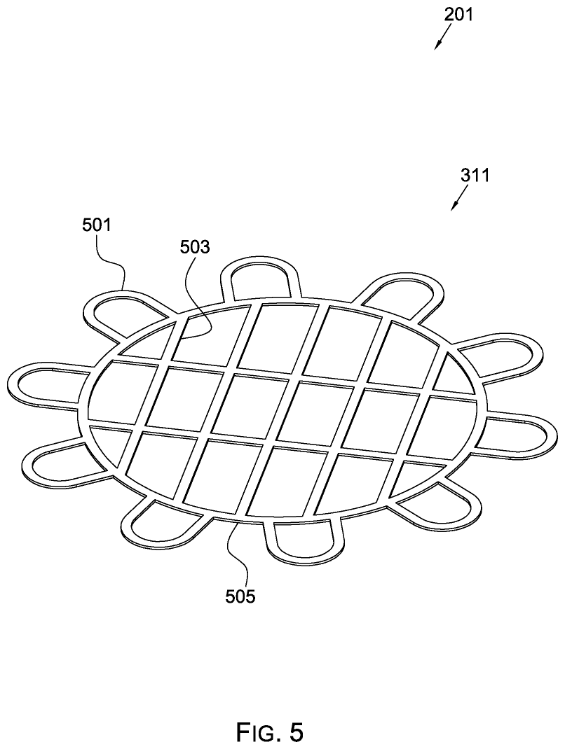

In FIG. 5, the net 311 is shown, having an interior weave 503 within a ring 505 and exterior loops 501. It should be appreciated that the net can vary in size and shapes, so long as the user can utilize the net for lifting and transporting the animal.

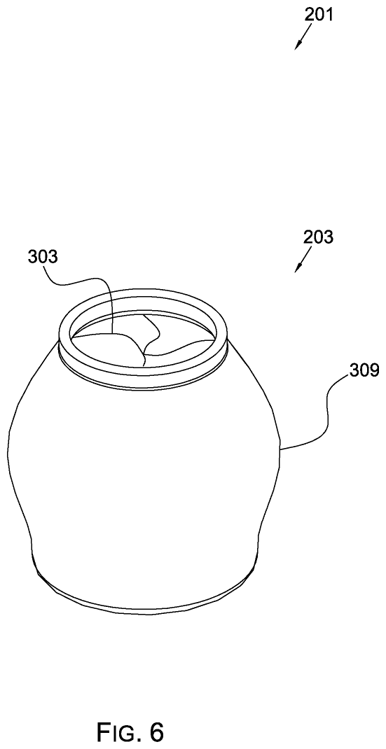

In FIG. 6, the apparatus 203 is shown in a folded configuration, wherein the base 303 is folded into the body 309, thereby providing for the apparatus 203 to be compact and easily transported.

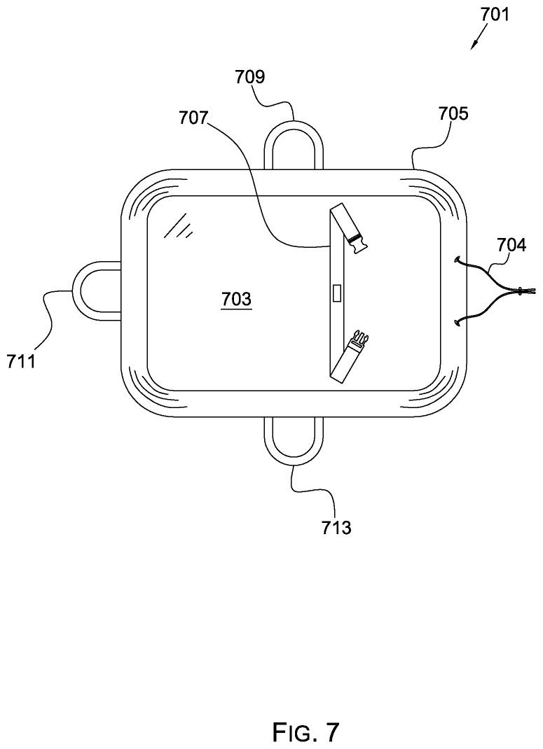

In FIG. 7, a top down view of an animal protection system 701 is shown, having the base 703 and the body 705 configured to secure to the body of the animal. In this embodiment, a drawstring 704 is provided for tightening around the neck of the animal for improved security. In some embodiments, a pocket can be included for storage of the drawstring when pulled to form the collar. In this embodiment, a strap 707 is further included that can secure to the body of the animal, again for improved security. In this particular embodiment, the strap is directly secured to the base, however, it should be appreciated that it could be included in alternative configurations. Further shown are a plurality of loops 709, 711, and 713 associated with the net positioned underneath the base.

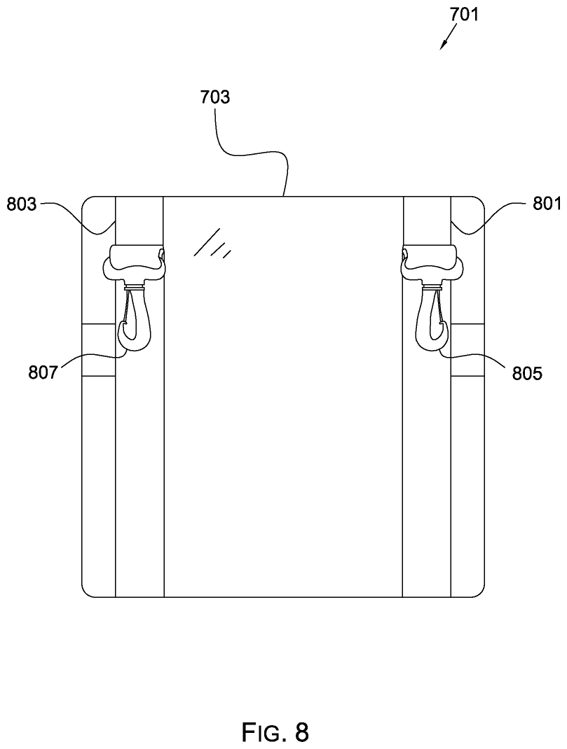

In FIG. 8, a back view of animal protection system 701 is shown in a folded compact configuration. In this configuration, the system further includes one or more straps 801, 803, with clips 805, 807, thereby providing the ability to secure to a seatbelt connection within a vehicle. It should be appreciated that this again provides for improved safety of an animal, such as while traveling.

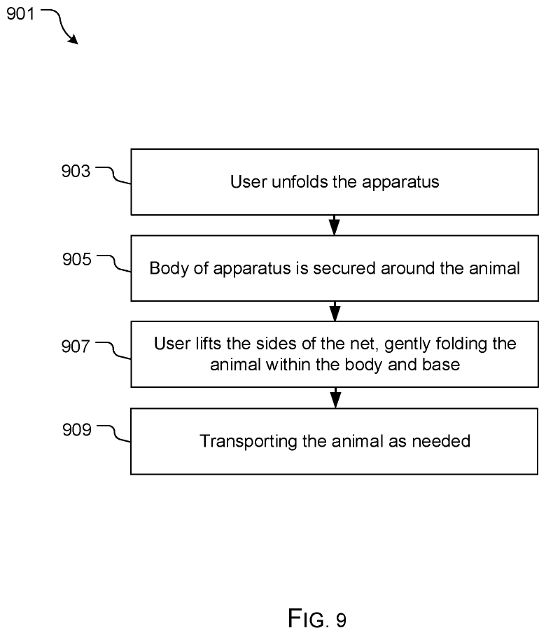

In FIG. 9, a flowchart 901 depicts the method of use of system 201 and 701. During use, the user can unfold the apparatus and secure the animal within the body, as shown with boxes 903, 905. The user (with or without help) can then gently fold the base around the animal and use the net to lift and carry the animal as needed, as shown with boxes 907, 909.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. An animal protection apparatus, comprising:
a body with a collar configured to secure around an animal's body and neck;
a padded base attached to the body; and
a net positioned under the padded base;
wherein the net and padded base can fold around the animal's body and can be used to lift and carry the animal.

2. The apparatus of claim 1, wherein the padded base further comprises:
a zipper configured to provide access to an interior area.

3. The apparatus of claim 1, wherein the net is removable from the base.

4. The apparatus of claim 1, further comprising:
a strap attached to the base and configured to secure around the animal's body.

5. The apparatus of claim 1, further comprising:
a drawstring secured in the body and configured to provide a means to tighten the body around the animal.

6. The apparatus of claim 1, further comprising:
one or more clips attached to the body and configured to secure to a seatbelt connection within a vehicle.

7. A method of transporting an animal, the method comprising:
providing a protection apparatus having a body, a base, and a net;
securing the body to an animal such that the animal is positioned on top of the base;
folding the base and net around the animal; and
using the net to transport the animal.
